(19) United States
(12) Patent Application Publication
(10) Pub. No.: US 2018/0127156 A1
(43) Pub. Date: May 10, 2018

(54) POUCH AND CONTENTS-ENCLOSING POUCH

(71) Applicant: TOPPAN PRINTING CO., LTD., Tokyo (JP)

(72) Inventors: Hidenobu MIYAKE, Tokyo (JP); Masashi GOTO, Tokyo (JP)

(73) Assignee: TOPPAN PRINTING CO., LTD., Tokyo (JP)

(21) Appl. No.: 15/861,357

(22) Filed: Jan. 3, 2018

Related U.S. Application Data
(63) Continuation of application No. PCT/JP2016/070027, filed on Jul. 6, 2016.

(30) Foreign Application Priority Data
Jul. 6, 2015 (JP) 2015-135295

(51) Int. Cl. B65D 33/25; B65D 33/24; B31B 70/81; B65D 51/24

(52) U.S. Cl. CPC B65D 33/2525; B65D 33/2591; B65D 2207/00; B31B 70/8132; B65D 51/243; B65D 33/24

(57) ABSTRACT

A pouch includes a bag body, a zipper, and a closing sheet. The bag body includes an accommodation space that can accommodate contents, a first aperture for opening the accommodation space, and a second aperture formed so as not to face the first aperture, for opening the accommodation space. The zipper is attached to the bag body, and unseals and seals the first aperture. The zipper includes a male part and a female part. The closing sheet is attached to the bag body so as to separate the male part and the female part of the zipper from the accommodation space. The closing sheet includes a weakened part that can be broken when unsealing of the zipper.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Application No. PCT/JP2016/070027, filed on Jul. 6, 2016, which is based upon and claims the benefit of priority of Japanese Patent Application No. 2015-135295, filed on Jul. 6, 2015, the entireties of which are hereby incorporated by reference.

### TECHNICAL FIELD

The present invention relates to a pouch that can accommodate contents, and relates to a contents-enclosing pouch with contents accommodated in the pouch.

### BACKGROUND ART

Pouches including accommodation spaces that can accommodate contents such as foods are known. As an example of such pouches, PTL 1 discloses a pouch including a pair of bag sheets that are sealed to each other to form an accommodation space, and a zipper for unsealing and sealing an aperture that opens the accommodation space. The zipper includes a single sheet, and a male part and a female part formed on the sheet. The single sheet includes a bent portion where the sheet is bent double such that the apex of the sheet projects toward the accommodation space.

The male part is formed in a first region, which is one region of the bent sheet. The female part is formed in a second region, which is the other region of the bent sheet. On the single sheet, the bent portion and its surroundings are a thinner than other portions. The back surfaces of the first region and of the second region are respectively sealed to the bag sheets. Therefore, the male part and the female part of the zipper are separated from the accommodation space by the single sheet including the folded portion.

### CITATION LIST

### Patent Literature

PTL 1: JP 2005-206162 A

### SUMMARY OF THE INVENTION

### Technical Problem

PTL 1 does not specify a manufacturing method of the above pouch. In light of general manufacturing methods of pouches, it is considered that the above pouch is manufactured through the following steps. First, a single sheet configuring a zipper is sealed to a respective pair of bag sheets, thereby separating a male part and a female part of the zipper from an accommodation space of the pouch. Next, respective sides of the pair of bag sheets other than bottom sides are sealed to each other to manufacture the pouch with the bottom opened.

Next, the pouch is mounted onto a filling machine such that the bottom thereof is directed upward, and contents are fed from the bottom aperture into the accommodation space. At that time, the fed contents are received by the single sheet so that the contents do not come into contact with the male part and the female part of the zipper. Lastly, the bottom of the pouch is sealed to manufacture the pouch with the accommodation space closed. Even if the contents move during a process of transferring the pouch, the single sheet prevents the contents from adhering to the male part and the female part of the zipper.

An end user who has obtained the above pouch cuts an upper side of the pouch which is sealed, to unseal an upper part of the pouch, thereby decoupling the male part and the female part of the zipper which are coupled. The bent portion of the single sheet is broken by a force applied to the sheet for decoupling the male part and the female part. Thus, the accommodation space of the pouch is opened. Since the single sheet prevents the contents from adhering to the male part and the female part of the zipper before an end user breaks the single sheet, the end user is less likely to visually recognize the contents-adhered male part and female part when he/she cuts the upper side of the pouch.

In manufacturing the above pouch, when a large amount of contents are fed from the bottom of the pouch into the accommodation space or when the contents drop at a high speed, the single sheet receives the fed contents with great force. This force may break the bent portion of the single sheet.

An object of the present invention is to provide a pouch and a contents-enclosing pouch in which contents are less likely to adhere to a male part and a female part of a zipper.

### Solution to Problem

In order to achieve the above object, a pouch according to one aspect of the present invention includes a bag body, a zipper, and a closing sheet. The bag body includes an accommodation space that can accommodate contents, a first aperture for opening the accommodation space, and a second aperture formed so as not to face the first aperture, for opening the accommodation space. The zipper is attached to the bag body, and unseals and seals the first aperture. The zipper includes a male part and a female part. The closing sheet is attached to the bag body so as to separate the male part and the female part of the zipper from the accommodation space. The closing sheet includes a weakened part that can be broken when unsealing of the zipper.

### BRIEF DESCRIPTION OF THE DRAWINGS

FIG. 1 is a front view of a pouch of a first embodiment.

FIG. 2 is a front view of a contents-enclosing pouch in which contents are accommodated in the pouch of FIG. 1.

FIG. 3 is a cross-sectional view taken along the line Z3-Z3 of FIG. 1.

FIG. 4 is a cross-sectional view taken along the line Z4-Z4 of FIG. 1.

FIG. 5 is a cross-sectional view which illustrates a zipper of the contents-enclosing pouch of FIG. 2 when unsealed.

FIG. 6 is a cross-sectional view of a pouch of a second embodiment.

FIG. 7 is a cross-sectional view of a pouch of a third embodiment.

FIG. 8 is a cross-sectional view of a pouch of a modified example.

### DESCRIPTION OF EMBODIMENTS

It is to be understood that the embodiments and Examples disclosed are representative of the present invention and that the present invention is not necessarily limited to the embodiments and Examples.

### First Embodiment

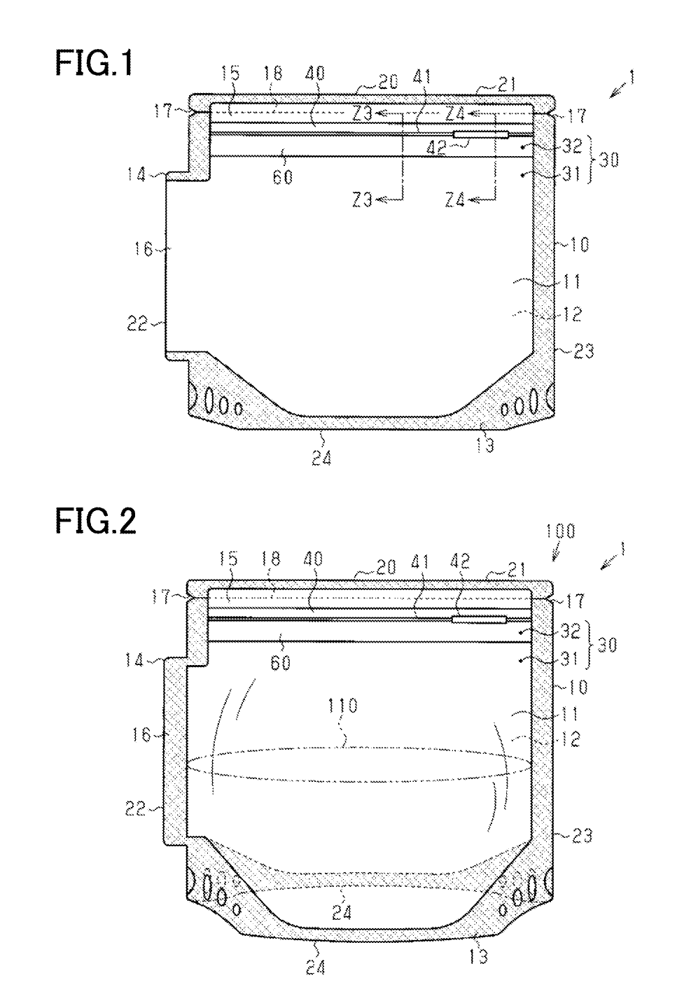

FIG. 1 shows an appearance of a standing pouch (hereinafter, referred to as “pouch 1”) in which contents are not enclosed. The pouch 1 as a container is provided with a bag body 10 including a first bag sheet 11 and a second bag sheet 12 facing each other and a gusset sheet 13 for making the pouch 1 stand by itself. The bag body 10 is configured by sealing the edges of the sheets 11-13 to form an internal space 30 including an accommodation space 31 that can accommodate contents 110 (see FIG. 2) and an opening space 32 connected to the accommodation space 31, thereby opening the accommodation space 31 to the outside. The term “sealed” used in the description of the present application means “closely attached inseparably (or unbreakably)” unless there is any particular description regarding the strength. The contents 110 are, for example, liquid seasonings that are to be eaten after cooking. The contents 110 are fed into the accommodation space 31, and then the pouch 1 is sealed, thereby, configuring a contents-enclosing pouch 100, which is the pouch 1 including the contents 110 as shown in FIG. 2. Dots shown in FIGS. 1 and 2 indicate sealed portions of the bag body 10.

Each of the sheets 11 to 13 is a laminated sheet having the same layer structure, and includes, for example, an outermost layer, an intermediate layer, and an innermost layer formed of transparent materials. An example of material configuring the outermost layer is polyethylene terephthalate. The intermediate layer includes, for example, a print layer, a first adhesive layer, an oriented nylon layer, and a second adhesive layer. The print layer is formed closer to the inside than the outermost layer with patterns, texts such as item description, and the like printed on the outer surface thereof. The first adhesive layer is formed closer to the inside than the print layer. The oriented nylon layer is formed on an inner side than the first adhesive layer. The second adhesive layer is formed on an inner side than the oriented nylon layer. The innermost layer is formed on an inner side than the second adhesive layer. An example of material configuring the innermost layer is non-oriented polypropylene.

The bag body 10 includes a plurality of sides 20, a projection part 14 formed at a lateral part of the bag so as to project outward from the center of the bag body 10, a first aperture 15 forming the opening space 32, and a second aperture 16 formed so as not to face the first aperture 15, for opening the accommodation space 31 at a position different from that of the first aperture 15. The plurality of sides 20 includes a first side 21, which is an upper side of the bag body 10, a second side 22, which is a side of one lateral part of the bag body 10, a third side 23, which is a side on the other lateral part of the bag body 10, and a pair of fourth sides 24, which are on a bottom side of the bag body 10.

An example of a position of the second aperture 16 not facing the first aperture 15 includes, among the plurality of sides 20, a side different from the first side 21 on which a side the first opening 15 is formed, and not facing the first side 21. An example of the side is the second side 22. The second aperture 16 is formed at, for example, the projection part 14 including the second side 22. When the first aperture 15 and the second aperture 16 are formed at the same side, this position of the second aperture 16 corresponds to one example of forming position not facing the first aperture 15.

As shown in FIG. 2, the plurality of sides 20 of the contents-enclosing pouch 100 is sealed. The first side 21 closes the first aperture 15. The second side 22 is a side including two curved portions, and closes one lateral part of the bag body 10 including the second aperture 16. The third side 23 closes the other lateral part of the bag body 10. The fourth side 24 closes the bottom of the bag body 10. A notch 17 is formed in each of upper parts of the second side 22 and of the third side 23. A dotted line 18 connected to the notches 17 is formed in a lower part of the first side 21. The dotted line 18 is formed from the second side 22 to the third side 23 along the first side 21. By cutting a part of the bag body 10 along the notches 17 and the dotted line 18, the first side 21 is detached from the bag body 10.

The first aperture 15 is used when an end user feeds the contents 110 and an object to be heated into the accommodation space 31, and takes out the heated contents 110 from the bag body 10. The second aperture 16 is an aperture of the bag body 10 that is used when in manufacturing the contents-enclosing pouch 100, and is not used by the end user.

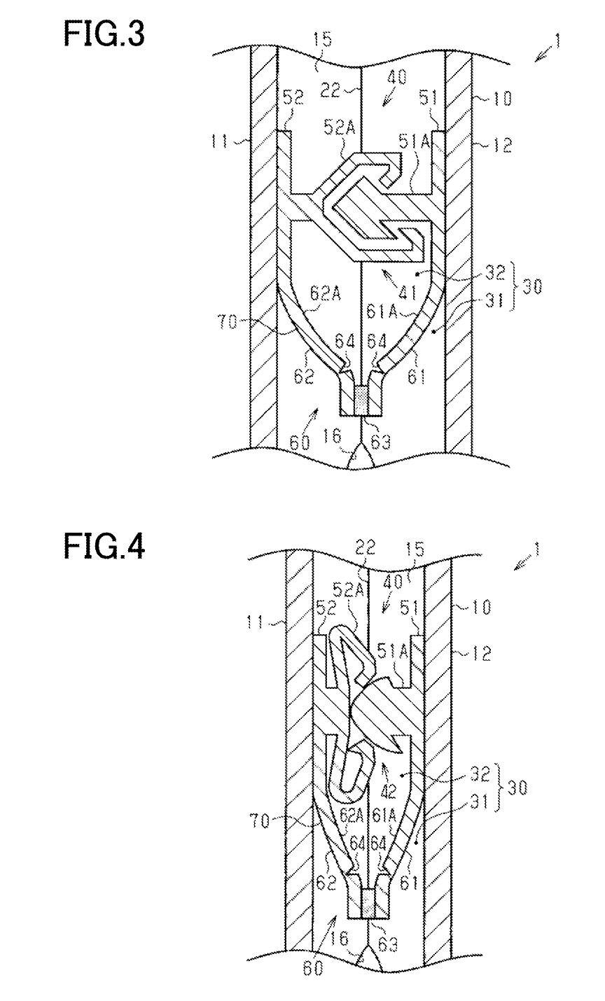

FIG. 3 shows a cross-sectional view taken along the line Z3-Z3 of FIG. 1. The pouch 1 is further provided with a zipper 40 attached to the bag body 10, for unsealing and sealing the first aperture 15.

The zipper 40 includes a male part 51A and a female part 52A that are fitted with each other, a male sheet 51 on which the male part 51A is formed, and a female sheet 52 on which the female part 52A is formed. The male part 51A and the male sheet 51 are integrally formed of a resin material. The female part 52A and the female sheet 52 are integrally formed of a resin material. An example of resin material configuring the zipper 40 is polypropylene. The back surface of the male sheet 51 is sealed to the inner surface of one of the first bag sheet 11 and the second bag sheet 12 from the second side 22 to the third side 23 (see FIG. 1). The back surface of the female sheet 52 is sealed to the inner surface of the other of the first bag sheet 11 and the second bag sheet 12 from the second side 22 to the third side 23. In the illustrated example, the male sheet 51 is sealed to the inner surface of the second bag sheet 12, and the female sheet 52 is sealed to the inner surface of the first bag sheet 11.

As shown in FIG. 1, the male part 51A and the female part 52A (see FIG. 3) include a general part 41 having a fitting strength suitable for unsealing by an end user, and an easy-opening portion 42 having a fitting strength lower than that of the general part 41. The length of the easy-opening portion 42 in a longitudinal direction of the zipper 40 is shorter than the length of the general part 41 in a longitudinal direction of the zipper 40. The easy-opening portion 42 is formed in a limited narrow range, for example, so as to divide the general part 41. FIG. 3 shows a structure of the general part 41 of the zipper 40.

As shown in FIG. 3, the pouch 1 is further provided with a closing sheet 60 for partitioning the internal space 30 of the bag body 10 into the accommodation space 31 and the opening space 32 in cooperation with the male sheet 51 and the female sheet 52. The accommodation space 31 includes a space where the contents 110 (see FIG. 2) are accommodated. The opening space 32 includes a space where the male part 51A and the female part 52A are arranged. That is, the closing sheet 60 is attached to the bag body 10 so as to separate the male part 51A and the female part 52A of the zipper 40 from the accommodation space 31. An example of material configuring the closing sheet 60 is polypropylene.

The closing sheet 60 includes a first closing sheet part 61 extending from the male sheet 51 toward the accommodation space 31, a second closing sheet part 62 extending from the female sheet 52 toward the accommodation space 31, and a seal part 63 where the first closing sheet part 61 and the second closing sheet part 62 are sealed. The first closing sheet part 61 and the second closing sheet part 62 respectively include facing surfaces 61A and 62A facing each other.

The seal part 63 is formed by sealing the facing surface 61A of the first closing sheet part 61, and the facing surface 62A of the second closing sheet part 62 each other at the ends closer to the accommodation space 31. That is, in the closing sheet 60, the seal part 63 is formed at a portion farthest from the zipper 40. The seal part 63 has such strength that it is not broken by a force applied to the bag body 10 for unsealing the zipper 40.

By sealing the first closing sheet part 61 and the second closing sheet part 62, the male sheet 51, the closing sheet 60, and the female sheet 52 configure a single sheet 70. That is, the sheet 70 partitions the internal space 30 of the bag body 10 into the accommodation space 31 on a lower part and the opening space 32 on an upper part.

The closing sheet 60 further includes a plurality of weakened parts 64 that can be broken when unsealing of the zipper 40. In an example, the plurality of weakened parts 64 includes a first weakened part 64 and a second weakened part 64. The first weakened part 64 is a notch formed at a portion closer to the seal part 63 of the facing surface 61A of the first closing sheet part 61 (or at any position between an intermediate portion and an end closer to the seal part 63) so as not to penetrate through the first closing sheet part 61. The second weakened part 64 is a notch formed at a portion closer to the seal part 63 of the facing surface 62A of the second closing sheet part 62 so as not to penetrate through the second closing sheet part 62.

Each of the weakened parts 64 is formed from one edge to the other edge of the closing sheet 60 along a longitudinal direction of the zipper 40. The notch has about half thickness of that of the closing sheet 60, for example. Each of the weakened parts 64 has such strength that it is broken by a force applied to the bag body 10 for decoupling the male part 51A and the female part 52A of the zipper 40.

FIG. 4 shows a structure of the easy-opening portion 42 of the zipper 40. The easy-opening portion 42 of the zipper 40 is a portion where at least one of the male part 51A and the female part 52A is deformed so that the male part 51A and the female part 52A of the zipper 40 do not substantially fit with each other. In an example, the fitting strength of the easy-opening portion 42 is substantially zero.

The pouch 1 and the contents-enclosing pouch 100 are manufactured by, for example, the following procedure.

As shown in FIG. 3, first, a molded product including the male part 51A, the male sheet 51, and the first closing sheet part 61, and a molded product including the female part 52A, the female sheet 52, and the second closing sheet part 62 are separately formed of resin. Next, the first closing sheet part 61 and the second closing sheet part 62 are sealed at the seal part 63, to form the single sheet 70 including the male sheet 51, the first closing sheet part 61, the second closing sheet part 62, and the female sheet 52. Next, the male sheet 51 and the female sheet 52 are respectively sealed to the bag sheets 11, 12, and edges of the respective sheets 11-13 except the second side 22 of the bag body 10 are sealed to one another, to manufacture the pouch 1 of FIG. 1 with the second aperture 16 opened.

Next, the pouch 1 is set to a filling machine (not shown) such that the second aperture 16 of the pouch 1 is directed upward, and contents 110 are fed from the second aperture 16 into the accommodation space 31 by the filling machine. Specifically, both adjacent portions positioned closer to the center of the bag body 10 than to the projection part 14 in the bag body 10 are chucked with a chuck of the filling machine, and a nozzle of the filling machine is inserted into the second aperture 16, and the contents 110 are fed from the nozzle to the accommodation space 31.

Lastly, the second aperture 16 of the pouch 1 is sealed by a sealing device (not shown), to manufacture the contents-enclosing pouch 100 of FIG. 2 with the first aperture 15 and the second aperture 16 closed. Specifically, both adjacent portions positioned closer to the center of the bag body 10 than to the projection part 14 in the bag body 10 are chucked with a chuck of the sealing device, and a head of the sealing device moves along, for example, the second side 22, to seal the second aperture 16.

Even if the contents 110 move during a process of transferring the contents-enclosing pouch 100, the single sheet 70 prevents the contents 110 from adhering to the male part 51A and the female part 52A of the zipper 40. Thus, the contents 110 are less likely to adhere to the male part 51A and the female part 52A before the first side 21 of the bag body 10 is cut and the zipper 40 is unsealed.

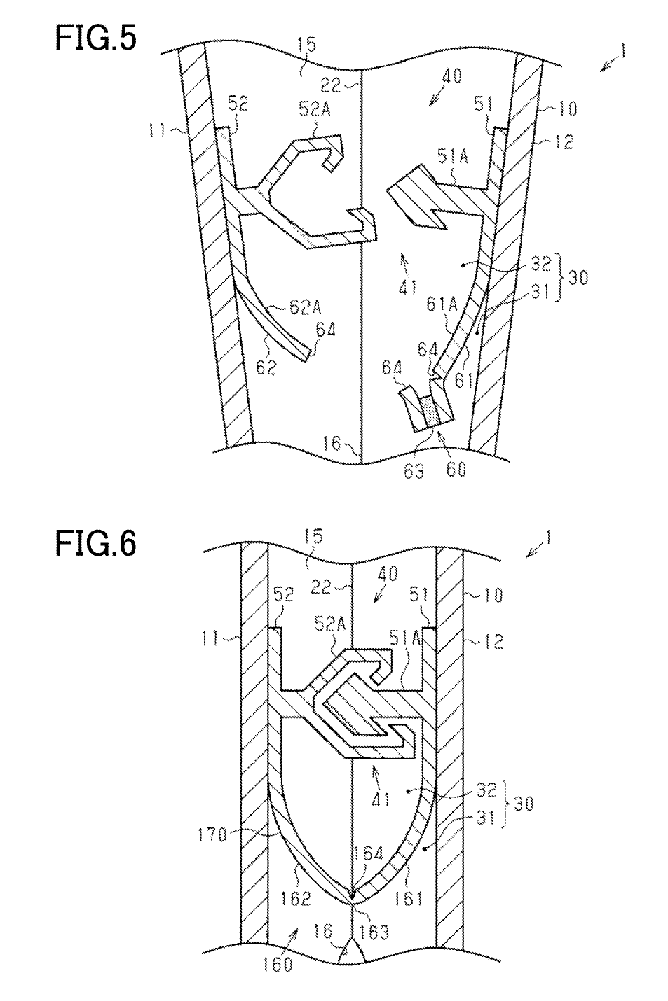

With reference to FIGS. 2 and 5, an example of the usage of the contents-enclosing pouch 100 will be shown.

An end user who uses the contents-enclosing pouch 100 cooks the foodstuff through the use of the contents-enclosing pouch 100 by the following procedure. The end user cuts the first side 21 of the bag body 10 along the dotted line 18. Accordingly, the zipper 40 can be opened. Next, as shown in FIG. 5, the end user unseals the zipper 40. Due to this unsealing operation, one of the first weakened part 64 and the second weakened part 64 of the closing sheet 60 is broken, thereby opening the first aperture 15. Therefore, the accommodation space 31 and the opening space 32 of the internal space 30 are connected to each other.

Next, the end user feeds the foodstuff from the first aperture 15 of the pouch 1 to the accommodation space 31, and closes the zipper 40 to seal the first aperture 15, and puts the pouch 1 in a heating means (heating device) such as a microwave. When the heating means heats the pouch 1, steam is generated from the contents 110, thereby increasing a pressure in the internal space 30 that has been sealed by the zipper 40. At this time, the contents 110 and the added foodstuff are steamed by the steam. With an increase in pressure in the internal space 30, steam retained in the internal space 30 flows to the outside of the pouch 1 through the easy-opening portion 42. Thus, even if steam is continuously generated from the contents 110, the pressure in the internal space 30 is prevented from being increased, and is less likely to be excessively high.

When a time taken to heat the pouch 1 reaches a prescribed time, the end user takes out the pouch 1 from the heating means such as a microwave and unseals the zipper 40, and takes out the contents 110 from the first opening 15. According to another usage of the pouch 1, after the first side 21 of the bag body 10 is cut along the dotted line 18, only the contents 110 previously accommodated in the bag body 10 are heated by the heating means without feeding any foodstuff into the accommodation space 31.

According to the pouch 1, the following effects and advantages can be obtained.

The second aperture 16 is formed at a position not facing the first aperture 15. Thus, when the contents 110 are fed from the second aperture 16 to the accommodation space 31 in the pouch 1, which has been set to the filling machine as described above, the fed contents 110 are mainly received by the third side 23, which is a portion facing the second aperture 16 in the bag body 10, and a great force is less likely to be applied to the weakened part 64 of the closing sheet 60. Therefore, the occurrence of breakage of the weakened part 64 may be reduced before an end user applies, to the bag sheets 11, 12, a force to decouple the male part 51A and the female part 52A, and hence, the contents 110 are less likely to adhere to the male part 51A and the female part 52A of the zipper 40.

According to the pouch 1 of the first embodiment, the following advantages can be further obtained.

(1) According to the pouch 1, since the first aperture 15 is formed on the first side 21 of the bag body 10 and the second aperture 16 is formed on the second side 22 of the bag body 10, a more wider region for the first aperture 15 can be obtained compared with the case where the first aperture 15 and the second aperture 16 are formed on the same side of the bag body 10. Thus, when an end user feeds the foodstuff and the like from the first aperture 15 to the accommodation space 31, workability thereof is enhanced.

(2) When the second aperture 16 of the pouch 1 is sealed, for example, both adjacent portions positioned closer to the center of the bag body 10 than to the projection part 14 in the bag body 10 are chucked with a chuck of a sealing device, and a head of the sealing device moves along the second side 22, to seal the second aperture 16. According to the pouch 1, since the second aperture 16 is formed in the projection part 14 of the bag body 10, a portion deviating from a movement track of the head of the sealing device can be chucked with the chuck of the sealing device. Thus, workability of sealing of the second aperture 16 is enhanced.

(3) According to the pouch 1, by applying, to the bag sheets 11, 12, a force to decouple the male part 51A and the female part 52A of the zipper 40, a stress is concentrated on a notch, which is the weakened part 64 of the closing sheet 60, and the closing sheet 60 is broken from the portion where the notch is formed in the closing sheet 60, and the accommodation space 31 is opened. This configuration reduces the occurrence of cobwebbing in a part of a seal when breaking the seal, unlike, for example, in the case where an aperture is formed in the closing sheet 60 and the aperture is sealed and the seal is broken by an end user.

(4) According to the pouch 1, since there is formed the single sheet 70 including the male sheet 51, the female sheet 52, and the closing sheet 60, a position of the closing sheet 60 with respect to the male part 51A and the female part 52A is determined. Thus, compared with the configuration in which the closing sheet 60 is sealed to the bag sheets 11, 12 separately from the male sheet 51 and the female sheet 52, a position of the closing sheet 60 with respect to the male part 51A and the female part 52A is correctly determined.

(5) According to the pouch 1, the first closing sheet part 61 and the second closing sheet 62 are sealed at the seal part 63. Thus, during a manufacturing process before the seal part 63 is formed, the male sheet 51 connected to the first closing sheet part 61 and the female sheet 52 connected to the second closing sheet part 62 can be handled individually. Thus, compared with the case where there is configured a single sheet in which the male sheet 51, the female sheet 52, and the closing sheet 60 are integrated, the range of choices is expanded for handling of each of the sheets 51, 52 at the time of manufacturing of the pouch 1.

(6) When a force is applied to a pair of bag sheets 11, 12 so that the male part 51A and the female part 52A of the zipper 40 are decoupled from each other, a force would also be applied to the closing sheet parts 61, 62 so that the facing surface 61A of the first closing sheet part 61 and the facing surface 62A of the second closing sheet part 62 are spaced apart from each other. Thus, according to the pouch 1 in which notches are formed on the respective facing surfaces 61A, 62A of the closing sheet parts 61, 62, an end user can readily break the notches.

(7) According to the pouch 1, by applying, to the bag sheets 11, 12, a force to decouple the male part 51A and the female part 52A of the zipper 40, a stress is likely to be concentrated on a portion of each of the closing sheet parts 61, 62 closer to the seal part 63. Thus, according to the pouch 1 in which the weakened part 64 is formed in a portion of each of the closing sheet parts 61, 62 closer to the seal part 63, an end user can readily break the weakened part 64.

### Second Embodiment

A pouch 1 of the second embodiment is different from the pouch 1 of the first embodiment in the feature described below, and has substantially the same configurations as those of the pouch 1 of the first embodiment in other features. In the description of the pouch 1 of the second embodiment, the configurations common to those of the pouch 1 of the first embodiment are given the same reference signs to omit a part of or a whole description of the configurations.

As shown in FIG. 6, the pouch 1 is provided with a closing sheet 160 instead of the closing sheet 60 of the first embodiment. A male sheet 51, the closing sheet 160, and a female sheet 52 configure a single sheet 170 that is integrally formed of a resin material. Thus, the sheet 170 partitions an internal space 30 of a bag body 10 into an accommodation space 31 on a lower part and an opening space 32 on an upper part. The sheet 170 is bent double in the closing sheet 60, and is joined to the bag body 10 in the male sheet 51 and the female sheet 52.

The closing sheet 160 is divided, at a bent portion 163 that is a bent portion of the sheet 170, into a first closing sheet part 161 and a second closing sheet part 162, and includes a weakened part 164 that can be broken when unsealing of a zipper 40.

The weakened part 164 is a notch formed on a surface facing the zipper 40 in the bent portion 163. This notch is formed along a longitudinal direction of the zipper 40 so as not to penetrate through the closing sheet 160. The depth of the notch is about half the thickness of the closing sheet 160. The weakened part 164 has such strength that it is broken by a force applied to the bag body 10 for decoupling the male part 51A and the female part 52A of the zipper 40. Thus, the weakened part 164 formed in the closing sheet 160 is broken by unsealing of the zipper 40, and a first opening 15 is opened.

The pouch 1 and a contents-enclosing pouch 100 are manufactured by, for example, the following procedure.

First, there is formed the single sheet 170 in which a formed article including the male part 51A and the male sheet 51, the closing sheet 160, and a formed article including the female part 52A and the female sheet 52 are integrally formed of a resin material. Next, the male sheet 51 and the female sheet 52 are respectively sealed to bag sheets 11, 12, and edges of the respective sheets 11-13 except a second side 22 of the bag body 10 are sealed to one another, to manufacture the pouch 1 of FIG. 1 with a second opening 16 opened.

Next, contents 110 are fed from the second aperture 16 into the accommodation space 31 of the pouch 1, similarly to the first embodiment. Lastly, the second aperture 16 of the pouch 1 is sealed, to manufacture the contents-enclosing pouch 100 of FIG. 2 with the first aperture 15 and the second aperture 16 closed, similarly to the first embodiment.

Even if the contents 110 move during a process of transferring the contents-enclosing pouch 100, the single sheet 170 prevents the contents 110 from adhering to the male part 51A and the female part 52A of the zipper 40. Thus, the contents 110 are less likely to adhere to the male part 51A and the female part 52A before an end user cuts a first side 21 of the bag body 10 to unseal the zipper 40.

According to the pouch 1 of the second embodiment, the following advantages can be further obtained as well as the effects and advantages (1)-(4) obtained by the first embodiment.

(8) According to the pouch 1, there is configured the single sheet 170 in which the male sheet 51, the closing sheet 160, and the female sheet 52 are integrally formed of a resin material. Thus, by respectively sealing the male sheet 51 and the female sheet 52 to the bag sheets 11, 12, the male part 51A and the female part 52A are separated from the accommodation space 31 by the closing sheet 160. Thus, the number of times sealing is required for manufacturing the pouch 1 is reduced compared with the configuration in which the male sheet 51, the female sheet 52, and the closing sheet 160 are individually sealed to the bag sheets 11, 12.

(9) According to the pouch 1 of the second embodiment, by applying, to the bag sheets 11, 12, a force to decouple the male part 51A and the female part 52A of the zipper 40, a stress is likely to be concentrated on the bent portion 163 of the closing sheet 160 compared with other portions of the closing sheet 160. Thus, according to the pouch 1 in which the weakened part 164 is formed in the bent portion 163 of the closing sheet 160, an end user can readily break the weakened part 164.

(10) When a force is applied to a pair of bag sheets 11, 12 such that the male part 51A and the female part 52A of the zipper 40 are decoupled from each other, a force would also be applied to the closing sheet parts 161, 162 such that the surface of the first closing sheet part 161 facing the zipper 40 and the surface of the second closing sheet part 162 facing the zipper 40 are spaced apart from each other. Thus, according to the pouch 1 in which a notch is formed on a surface of the closing sheet 160 facing the zipper 40, an end user can readily break the notch.

### Third embodiment

A pouch 1 of the third embodiment is different from the pouch 1 of the first embodiment in the feature described below, and has substantially the same configurations as those of the pouch 1 of the first embodiment in other features. In the description of the pouch 1 of the third embodiment, the configurations common to those of the pouch 1 of the first embodiment are given the same reference signs to omit a part of or a whole description of the configurations.

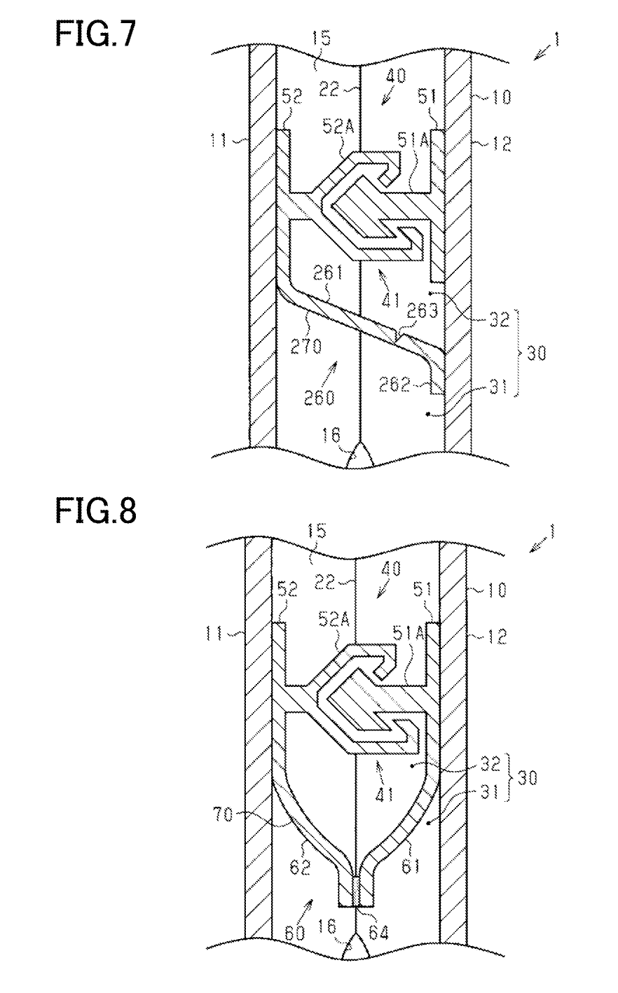

As shown in FIG. 7, the pouch 1 is provided with a closing sheet 260 instead of the closing sheet 60 of the first embodiment. There is configured a single sheet 270 in which either a male sheet 51 or a female sheet 52, and the closing sheet 260 are integrally molded by a resin material. In the illustrated example, the single sheet 270 is made up of the female sheet 52 and the closing sheet 260.

The closing sheet 260 includes a closed part 261 extending from the female sheet 52 toward an accommodation space 31, and a seal part 262 that is sealed to an inner surface of a second bag sheet 12 to which the male sheet 51 is attached. The closed part 261 is a portion between the female sheet 52 and the seal part 262 in the closing sheet 260. The seal part 262 is formed, for example, in an end of the closing sheet 260, and has such strength that it is not broken by a force applied to the bag body 10 for unsealing the zipper 40.

The closing sheet 260 further includes a weakened part 263 that can be broken when unsealing of the zipper 40. The weakened part 263 is a notch formed on the surface of the closed part 261 of the closing sheet 260 facing the zipper 40. This notch is formed along a longitudinal direction of the zipper 40 so as not to penetrate through the closing sheet 260. The depth of the notch is about half the thickness of the closing sheet 260. The weakened part 263 has such strength that it is broken by a force applied to the bag body 10 for decoupling a male part 51A and a female part 52A of the zipper 40. Thus, the weakened part 263 formed in the closing sheet 260 is broken by unsealing the zipper 40, and a first opening 15 is opened.

The pouch 1 and a contents-enclosing pouch 100 are manufactured by, for example, the following procedure.

First, a molded product including the male part 51A and the male sheet 51, and a formed article including the female part 52A, the female sheet 52 and the closing sheet 260 are separately resin-molded. Next, the male sheet 51 and the female sheet 52 are respectively sealed to the bag sheets 11, 12, and the seal part 262 of the closing sheet 260 is sealed to the inner surface of the second bag sheet 12. This forms the single sheet 270 including the female sheet 52 and the closing sheet 260. Next, edges of the respective sheets 11-13 except a second side 22 of the bag body 10 are sealed to one another, to manufacture the pouch 1 of FIG. 1 with the second opening 16 opened.

Next, contents 110 are fed from the second aperture 16 into an accommodation space 31 of the pouch 1, similarly to the first embodiment. Lastly, the second aperture 16 of the pouch 1 is sealed, to manufacture the contents-enclosing pouch 100 of FIG. 2 with the first opening 15 and the second opening 16 closed, similarly to the first embodiment.

Even if the contents 110 move during a process of transferring the contents-enclosing pouch 100, the single sheet 270 prevents the contents 110 adhering to the male part 51A and the female part 52A of the zipper 40. Thus, the contents 110 are less likely to adhere to the male part 51A and the female part 52A before an end user cuts a first side 21 of the bag body 10 and unseals the zipper 40.

According to the pouch 1 of the third embodiment, the following advantages can be further obtained as well as the effects and advantages (1)-(3) obtained by the first embodiment.

(11) According to the pouch 1, during a manufacturing process before the male sheet 51 and the female sheet 52 are respectively sealed to the bag sheets 11, 12, the male sheet 51 and the female sheet 52 connected to the closing sheet 260 can be handled individually. Thus, compared with the case where there is configured the single sheet in which the male sheet 51, the female sheet 52, and the closing sheet 260 are integrated, the range of choices is expanded for handling of each of the sheets 51, 52 at the time of manufacturing of the pouch 1.

(12) When a force is applied to a pair of bag sheets 11, 12 such that the male part 51A and the female part 52A of the zipper 40 are decoupled from each other, a force would be applied such that a surface of the closing sheet 260 facing the zipper 40 is pulled. Thus, according to the pouch 1 in which the notch is formed on the surface of the closing sheet 260 facing the zipper 40, an end user can readily break the notch.

### MODIFIED EXAMPLES

The description of each of the embodiments described above is only an exemplary form of the pouch and the contents-enclosing pouch according to the present invention, and it is not intended that forms thereof are limited. The pouch and the contents-enclosing pouch according to the present invention could include, as well as each of the embodiments described above, for example, modified examples of the embodiments shown below, and combinations of at least two of the modified examples that are mutually consistent.

A form of the closing sheet 60 of the first embodiment can be arbitrarily changed. In an example, the first closing sheet part 61 and the second closing sheet part 62 forming the closing sheet 60 are formed separately from the zipper 40. The first closing sheet part 61 is sealed to an inner surface of one of the first bag sheet 11 and the second bag sheet 12. The second closing sheet part 62 is sealed to an inner surface of the other of the first bag sheet 11 and the second bag sheet 12. The first closing sheet part 61 and the second closing sheet part 62 are sealed at the seal part 63.

A position of the first weakened part 64 of the first embodiment can be arbitrarily changed. In an example, the weakened part 64 is formed at a portion closer to the zipper 40 of the first closing sheet part 61 (or at any position between an intermediate portion and an end closer to the zipper 40) or an intermediate portion of the first closing sheet part 61. In another example, the first weakened part 64 is formed on a surface opposite to the facing surface 61A of the first closing sheet part 61. This weakened part 64 is formed at a portion closer to the seal part 63 of the first closing sheet part 61 (or at any position between an intermediate portion and an end closer to the seal part 63), or at a portion closer to the zipper 40 of the first closing sheet part 61 (or at any position between an intermediate portion and an end closer to the zipper 40), or at an intermediate portion of the first closing sheet part 61. A position of the second weakened part 64 can also be changed similarly.

A form of the weakened part 64 of the first embodiment can be arbitrarily changed. FIG. 8 shows one example of the weakened part 64 of a modified example. This weakened part 64 is a portion where the first closing sheet part 61 and the second closing sheet part 62 are weakly sealed. The weakened part 64 has such strength that it is broken by a force applied to the bag body 10 for decoupling the male part 51A and the female part 52A.

A form of the closing sheet 160 of the second embodiment can be arbitrarily changed. In an example, the closing sheet 160 may be formed separately from the zipper 40. The first closing sheet part 161 may be sealed to an inner surface of one of the first bag sheet 11 and the second bag sheet 12. The second closing sheet part 162 may be sealed to an inner surface of the other of the first bag sheet 11 and the second bag sheet 12.

A position of the weakened part 164 of the second embodiment can be arbitrarily changed. In an example, the weakened part 164 may be formed in a portion different from the bent portion 163 in the closing sheet 160.

A form of the closing sheet 260 of the third embodiment can be arbitrarily changed. In an example, the closing sheet 260 may be formed so as to extend from the male sheet 51 toward the accommodation space 31, and may be sealed to an inner surface of the first bag sheet 11.

The number of the weakened parts 64 of the first embodiment, of the weakened parts 164 of the second embodiment, and of the weakened parts 263 of the third embodiment can be arbitrarily changed. In an example, the weakened part 64 may be formed in only one of the first closing sheet part 61 and the second closing sheet part 62 in the first embodiment.

A form of each of the weakened parts 64, 164, 263 of each of the embodiments can be arbitrarily changed as long as it has such strength that it is broken by a force applied to the bag body 10 for decoupling the male part 51A and the female part 52A of the zipper 40. In an example, each of the weakened parts 64, 164, 263 may be formed discontinuously in a longitudinal direction of the zipper 40. In another example, each of the weakened parts 64, 164, 263 may be a thin part thinner than other portions of each of the closing sheets 60, 160, 260. In yet another example, each of the weakened parts 64, 164, 263 may be perforation.

A fitting form of the male part 51A and the female part 52A can be arbitrarily changed. In an example, the easy-opening portion 42 may be omitted from the zipper 40, and the entire male part 51A and female part 52A may be configured as the general part 41.

A position of the projection part 14 of the bag body 10 can be arbitrarily changed. In an example, the projection part 14 may be formed so as to project laterally outward from the third side 23.

According to the pouch 1 of a modified example, the projection part 14 may be omitted from the bag body 10.

A position of the second aperture 16 can be arbitrarily changed as long as it does not face the first opening 15. In an example, the second aperture 16 may be formed on the third side 23 of the bag body 10. In another example, the first aperture 15 and the second aperture 16 may be formed on the same side of the bag body 10. An example of the same side may be the first side 21, the second side 22, or the third side 23. A position of the second aperture 16 not facing the first aperture 15 can be a position where the contents 110 that have passed the second aperture 16 are not in strong contact with the weakened part 64 of the closing sheet 60 when the contents 110 are fed from the second aperture 16 into the accommodation space 31.

A structure of the bag body 10 can be arbitrarily changed. In an example, the first bag sheet 11 and the second bag sheet 12 are formed by bending a single bag sheet, and edges thereof are sealed to each other, to form the bag body 10.

A form of the pouch 1 can be arbitrarily changed. In an example, the pouch 1 has a form of a flat pouch instead of a standing pouch. According to this modified example, a gusset sheet 13 is omitted from the bag body 10.

Uses of the pouch 1 can be arbitrarily changed. In an example, the pouch 1 is used for accommodating foods that do not need to be heated, or contents other than foods.

What is claimed is:

1. A pouch comprising:
a bag body including an accommodation space that can accommodate contents, a first aperture for opening the accommodation space, and a second aperture formed so as not to face the first aperture, for opening the accommodation space;
a zipper attached to the bag body, for unsealing and sealing the first aperture, the zipper including a male part and a female part; and
a closing sheet attached to the bag body so as to separate the male part and the female part of the zipper from the accommodation space, the closing sheet including a weakened part that can be broken when unsealing of the zipper.

2. The pouch of claim 1, wherein
the bag body includes at least a first side and a second side,
the first aperture is formed on the first side, and
the second aperture is formed on the second side.

3. The pouch of claim 2, wherein
the pouch is a standing pouch,
the first side is a side on an upper part of the bag body, and
the second side is a side on a side part of the bag body.

4. The pouch of claim 2, wherein
the bag body includes a projection part formed so as to project outward, and
the projection part includes the second side.

5. The pouch of claim 1, wherein
the weakened part is a notch formed so as not to penetrate through the closing sheet.

6. The pouch of claim 1, wherein
the zipper further includes a male sheet in which the male part is formed and a female sheet in which the female part is formed,
the closing sheet includes a first closing sheet part extending from the male sheet toward the accommodation space and a second closing sheet part extending from the female sheet toward the accommodation space and connected to the first closing sheet part, and
the male sheet, the first closing sheet part, the second closing sheet part, and the female sheet configure a single sheet.

7. The pouch of claim 6, wherein
the closing sheet includes a seal part where the first closing sheet part and the second closing sheet part are sealed, and
the weakened part is formed in at least one of the first closing sheet part and the second closing sheet part.

8. The pouch of claim 5, wherein
the zipper further includes a male sheet in which the male part is formed and a female sheet in which the female part is formed,
the closing sheet includes a first closing sheet part extending from the male sheet toward the accommodation space and a second closing sheet part extending from the female sheet toward the accommodation space and connected to the first closing sheet part,
the male sheet, the first closing sheet part, the second closing sheet part, and the female sheet configure a single sheet,
the closing sheet includes a seal part where the first closing sheet part and the second closing sheet part are sealed,
the weakened part is formed in at least one of the first closing sheet part and the second closing sheet part,
the first closing sheet part and the second closing sheet part respectively include facing surfaces being faced to each other, and
the notch is formed on the facing surface of at least one of the first closing sheet part and the second closing sheet part.

9. The pouch of claim 6, wherein
the male sheet, the first closing sheet part, the second closing sheet part, and the female sheet configure an integrally-formed single sheet, and
the closing sheet includes a bent portion where the closing sheet is bent double so as to project toward the accommodation space.

10. The pouch of claim 9, wherein
the weakened part is formed in the bent portion.

11. The pouch of claim 1, wherein
the zipper further includes a male sheet in which the male part is formed, and a female sheet in which the female part is formed,
the closing sheet extends from one of the male sheet and the female sheet toward the accommodation space,
the closing sheet includes a seal part that is sealed to an inner surface of the bag body to which the other of the male sheet and the female sheet is attached, and
the weakened part is formed in a portion between either the male sheet or the female sheet and the seal part in the closing sheet.

12. A contents-enclosing pouch comprising:
the pouch of claim 1; and
contents accommodated in the accommodation space, wherein
the first aperture and the second aperture are closed.
